(19) United States
(12) Patent Application Publication
(10) Pub. No.: US 2018/0248268 A1
(43) Pub. Date: Aug. 30, 2018

(54) ELECTRO-OPTICAL DEVICE UTILIZING AN ARRAY OF PLASMONIC FIELD-EFFECT TRANSISTORS

(71) Applicant: Board of Regents, The University of Texas System, Austin, TX (US)

(72) Inventors: Gennady Shvets, Ithaca, NY (US); Nima Dabidian, Austin, TX (US)

(21) Appl. No.: 15/901,408

(22) Filed: Feb. 21, 2018

Related U.S. Application Data
(60) Provisional application No. 62/463,382, filed on Feb. 24, 2017.

(51) Int. Cl. H01Q 15/00

(52) U.S. Cl. CPC H01Q 15/0086; G02B 5/28; G02F 2203/11

(57) ABSTRACT

An electro-optical device using a plasmonic metasurface. The electro-optical device includes an electro-optical substrate and an array(s) of plasmonic unit cells forming a plasmonic metasurface fabricated on the substrate, where each of the plasmonic unit cells mimics a field-effect transistor. In each of the plasmonic unit cells, there is a drain and a source antenna separated from each other via a gap. In such a structure, a gate contact is not required thereby simplifying device fabrication. Furthermore, the device can be scaled to cover a large frequency range and have a flexible optical response, which is used to detect the presence of biomolecules. For example, the presence of a biomolecule is detected by observing a change in the electrical properties of the substrate in the gap region caused by a change in the substrate temperature which was caused by a change in the optical absorption of the plasmonic unit cell(s).

### TECHNICAL FIELD

The present invention relates generally to electro-optics, and more particularly to an electro-optical device utilizing an array of plasmonic field-effect transistors.

### BACKGROUND

Electro-optics is a branch of electrical engineering and material physics involving components, devices (e.g., lasers, light emitting diodes, light modulators, etc.) and systems which operate by the propagation and interaction of light with various tailored materials. Specifically, electro-optics concerns the interaction between the electromagnetic (optical) and the electrical (electronic) states of materials.

Electro-optical devices are becoming part of day-to-day life in wearable technology and biosensors that integrate with smartphones and watches to measure biometrics. However, such electro-optical devices currently use power inefficiently and require complicated fabrication processes to be manufactured. Furthermore, the functionality of these electro-optical devices is limited.

### SUMMARY

In one embodiment of the present invention, an electro-optical device comprises an electro-optical substrate. The electro-optical device further comprises one or more arrays of plasmonic unit cells forming a plasmonic metasurface fabricated on the electro-optical substrate, where each of the plasmonic unit cells mimics a field-effect transistor.

In another embodiment of the present invention, a method for detecting biomolecules comprises detecting a change in physical properties of a thermochromic substrate based on a change in temperature of the thermochromic substrate which is based on a change in an amount of optical absorption due to a presence of a biomolecule with an absorption fingerprint that matches a resonance frequency of an array of plasmonic unit cells. The method further comprises detecting a presence of a biomolecule in response to detecting the change in the physical properties of the thermochromic substrate.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an electro-optical device that includes an electro-optical substrate with a plasmonic metasurface fabricated on the electro-optical substrate in accordance with an embodiment of the present invention;

FIG. 2 illustrates a plasmonic unit cell in accordance with an embodiment of the present invention;

FIG. 3A depicts a broadband plasmonic field-effect transistor (PFET) (linearly dichroic) that only responds to x-polarization in accordance with an embodiment of the present invention;

FIG. 3B depicts a chiral PFET that distinguishes left-handed and right-handed circularly polarized light (and different ellipticities) in accordance with an embodiment of the present invention;

FIG. 3C depicts a narrowband PFET (Fano-resonant) that provides a narrow-width resonance for x-polarization only in accordance with an embodiment of the present invention;

FIG. 3D depicts the metasurface using the PFET of FIG. 3A in accordance with an embodiment of the present invention;

FIG. 3E depicts the metasurface using the PFET of FIG. 3B in accordance with an embodiment of the present invention;

FIG. 3F depicts the metasurface using the PFET of FIG. 3C in accordance with an embodiment of the present invention;

FIG. 4A illustrates the absorption spectrum for the chiral metasurface in accordance with an embodiment of the present invention;

FIG. 4B illustrates the AC current profile at the resonance for the left-handed circular polarization in accordance with an embodiment of the present invention;

FIG. 4C illustrates the z-component of the electric field corresponding to the electric charge profile at the resonance in accordance with an embodiment of the present invention; and

FIG. 4D illustrates the graphene absorption in the gap for the narrowband Fano-resonance PFET shown in FIG. 3F in accordance with an embodiment of the present invention.

### DETAILED DESCRIPTION

The principles of the present invention provide a new class of electro-optical devices. The electro-optical devices of the present invention have different optical functionalities according to their design. They have a large bandwidth operation with a flexible optical response. Furthermore, the electro-optical devices of the present invention can be fabricated using traditional lithographic processes.

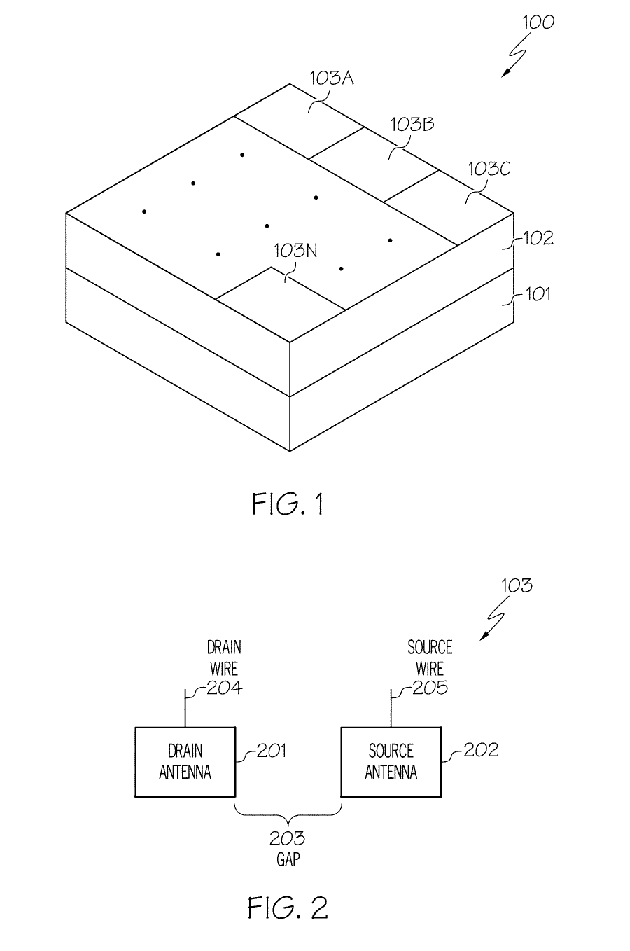

Referring now to the Figures in detail, FIG. 1 illustrates an electro-optical device 100 that includes an electro-optical substrate 101 with a plasmonic metasurface 102 fabricated on electro-optical substrate 101 in accordance with an embodiment of the present invention. In one embodiment, plasmonic metasurface 102 is fabricated on graphene as the electro-optical material. In one embodiment, plasmonic metasurface 102 is formed by an array of plasmonic unit cells 103A-103N, where N is a positive integer number. Each unit cell of the array of plasmonic unit cells may be referred to herein with element number 103. Furthermore, a collection of unit cells of the array of plasmonic unit cells may also be referred to herein with element number 103. In one embodiment, each unit cell 103 mimics a field-effect transistor (FET) (also referred to herein as a “plasmonic FET” or simply “PFET”). In one embodiment, the array of plasmonic unit cells 103 may consist of a periodic array of 5 to 10 PFETs in each direction which consists of an area as small as 3*3 wavelengths. While FIG. 1 illustrates a single array of plasmonic unit cells 103, electro-optical device 100 may include multiple arrays. For example, in an area of 100*100 micrometers, one may use several arrays of plasmonic unit cells 103 with resonances covering mid-infrared frequencies thereby allowing electro-optical device 100 to function as a mid-infrared spectrometer. These arrays may not only detect the intensity but also derive the polarization state of light. Electro-optical device 100 of FIG. 1 is not to be limited in scope to the particular number of plasmonic unit cells 103 depicted in FIG. 1. Electro-optical device 100 of the present invention may be implemented in various devices, such as a photodetector array, an optical modulator, a multispectral imaging device or a tunable filter. Electro-optical device 100 may include any number of plasmonic unit cells 103 as well as any number of arrays of plasmonic unit cells 103. A more detailed description of plasmonic unit cell 103 is discussed below in connection with FIG. 2.

FIG. 2 illustrates a plasmonic unit cell 103 (FIG. 1) in accordance with an embodiment of the present invention. Referring to FIG. 2, in conjunction with FIG. 1, cell 103 includes a drain antenna 201 and a source antenna 202 separated by a gap 203. Antennas 201, 202 are attached to drain and source wires 204, 205, respectively. In one embodiment, wires 204, 205 run along the y-direction. In one embodiment, antennas 201, 202 enhance AC electromagnetic fields in gap 203. In one embodiment, the shape of antennas 201, 202 determine its optical functionality.

Furthermore, in one embodiment, antennas 201, 202 enable active gating of electro-optical device 100. For example, antennas 201, 202 may serve as electrodes. A DC or AC voltage (or a pulse) between drain and source antennas 201, 202 can control the optical properties (index of refraction) of electro-optical substrate 101 in gap 203 (channel) and thereby modulate the AC field.

Additionally, in one embodiment, drain and source antennas 201, 202 serve as electrodes for data acquisition. The conductivity of gap 203 (channel) can be related to the index of refraction and temperature by calibration. In one embodiment, substrate 101 consists of a band-gap material. In another embodiment, substrate 101 consists of a doped semiconductor (e.g., silicon useful for high-speed modulating of light) or a phase transition metal-oxide (e.g., vanadium dioxide (VO₂) useful for sensing and low-speed modulation of light). Transition metal-oxide materials (e.g., VO₂, titanium dioxide (TiO₂), aluminum oxide (Al₂O₃)) transition between an oxide and a metal at a certain temperature (depending on the material) where resistivity changes by 3 to 4 orders of magnitude. While the former uses depletion of the channel from the charge carrier to modify the index of refraction, the latter uses the bolometric effect. The former effect can operate in the gigahertz-rate, which is an appropriate speed for telecommunications. The latter effect has a millisecond response time, which is appropriate for applications, such as biosensing and display technology.

In one embodiment, metasurface 102 has a resonance where the electromagnetic fields in gap 203 are enhanced by ˜100 times. This will enhance the interaction energy by 10,000 times in gap 203. In the case of transition metal-oxides, this will increase the temperature of substrate 101 (only in gap 203). Source and drain electrodes 202, 201 then read resistance between the drain and source for each unit cell 103 (also referred to herein as the “nanosensor”). Proximity of a biomaterial (e.g., biomolecule, biocell, DNA) will affect the electromagnetic fields of gap 203 if they possess a molecular fingerprint that matches the resonance frequency of metasurface 102. This is due to the additional loss that lowers the field enhancement. This will in turn change the local temperature in gap 203 and cause substrate 101 to enter through a phase-transition. A data acquisition system can then read the local resistance of each nanosensor 103 to identify the presence of such a biomaterial target.

Furthermore, electro-optical device 100 of the present invention exhibits low-power consumption. The low-power consumption is due to the fact that the active region of electro-optical device 100 is only gap 203 and not the whole substrate 101 which is what makes device 100 so efficient. The electromagnetically active region corresponds exactly to the control and data acquisition region. Furthermore, gap 203 is small (≈100 nm). Therefore, it requires a small amount of power for controlling and acquiring data and makes it a candidate for wearable technology.

In one embodiment, device 100 may be utilized in biosensing. Two of the major common biosensing approaches are field-effect transistor (FET) biosensors and optical biosensors based on spectroscopy. FET-based biosensors are based on measuring current-voltage (I-V) curves of a transistor. With FET-based biosensors, the concentration of a certain target molecule modifies the conductivity of the transistor channel. The conductivity is then used to predict the concentration of the target molecule in the solution. Spectroscopy can provide more information about the molecule types (e.g., orientation, thickness) according to their absorption fingerprints. Spectroscopy has been long used as a non-destructive method of biosensing whose performance is improved by plasmonics (e.g., Surface Enhanced InfraRed Absorption (SEIRA)). However, they require spectrometers, which are expensive. The device of the present invention bridges between these two technologies. For example, measuring the resistance of substrate 101 between drain and source electrodes 201, 202 of the FET 103 can replace spectroscopic measurement. Hence, device 100 provides a spectroscopy-free optical biosensing platform.

Moreover, plasmonic field-effect transistors (PFETs) 103 can attract the biomolecules close to gap 203 by dielectrophoresis (DEP). The gradient of optical fields around the tip of drain and source 201, 202 and right above gap 203 will trap the biomolecule and levitate them close to the gap region where the electromagnetic fields are large. Similarly, an AC voltage applied to drain and source 201, 202 can trap the biomolecules into the gap regions. Furthermore, in one embodiment, a voltage applied to drain and source wires 204, 205 causes biomolecules to attract to wires 204, 205.

In one embodiment, biomaterial, such as biomolecules, are detected based on detecting a change in the physical properties (e.g., electrical conductivity) of substrate 101 (FIG. 1), which is based on a change in the temperature of substrate 101, which is based on a change in an amount of optical absorption due to the presence of a biomolecule with an absorption fingerprint that matches a resonance frequency of an array of plasmonic unit cells 103 (FIG. 1). In one embodiment, such a substrate 101 is a thermochromic substrate, which includes an oxide or a sulfide of a transition metal (e.g., transition metal-oxide) that undergoes a change in its crystalline structure below and above a specific temperature (i.e., its transition temperature (Tc)), whereby its physical properties (electrical conductivity and infrared (IR) transmittance) suddenly change. The physical properties (e.g., electrical conductivity) may then be measured via a meter (e.g., electric conductivity meter). In one embodiment, the temperature of substrate 101 is based in part on the amount of optical absorption performed by plasmonic unit cells 103 (FIGS. 1 and 2). There may be a change in the amount of optical absorption, which occurs at one or more unit cells 103, in response to the presence of a biomolecule in the vicinity of those unit cells 103. As a result of the change in the amount of optical absorption due to the presence of a biomolecule, the temperature of substrate 101 changes which causes a change in the electrical properties of substrate 101 which may be detected by a meter. The change in the electrical properties of substrate 101 may then signify the presence of a biomolecule.

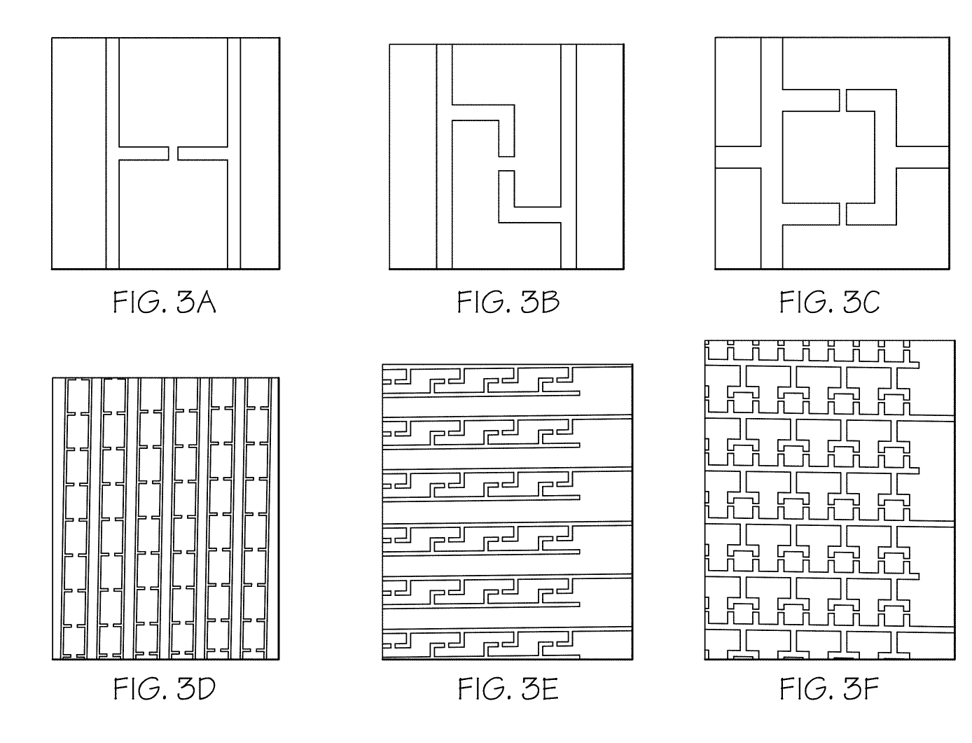

Referring now to FIGS. 3A-3F, FIGS. 3A-3F depict a scanning electron microscope (SEM) image of plasmonic field-effect transistors (PFET) 103 (FIGS. 1 and 2) for different optical applications in accordance with an embodiment of the present invention. All PFETs 103 are connected to drain and source wires 204, 205 (FIG. 2) directly that run across the metasurface 102 (FIG. 1).

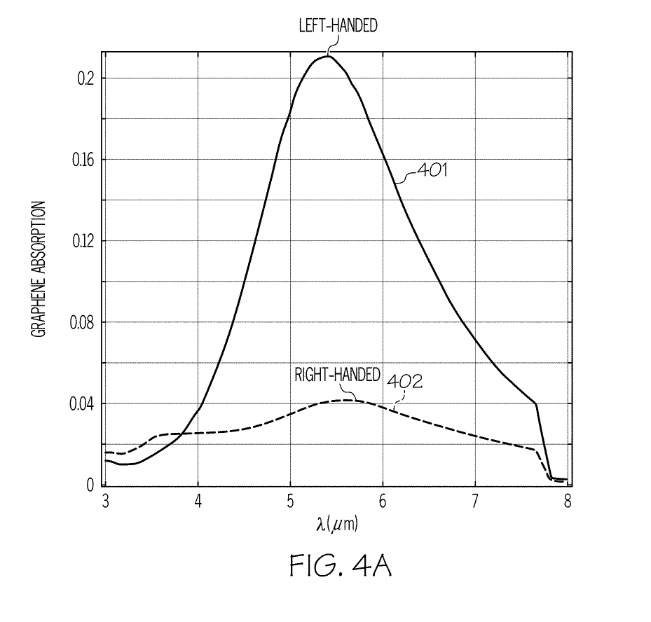

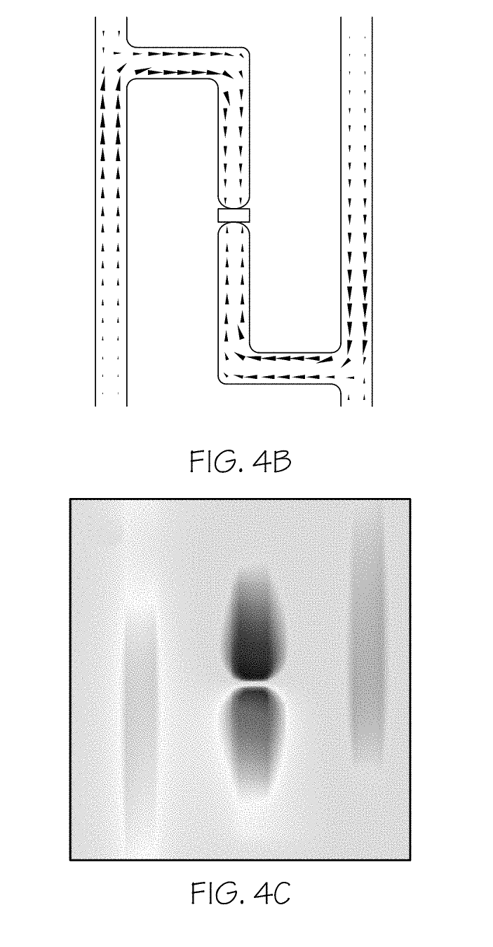

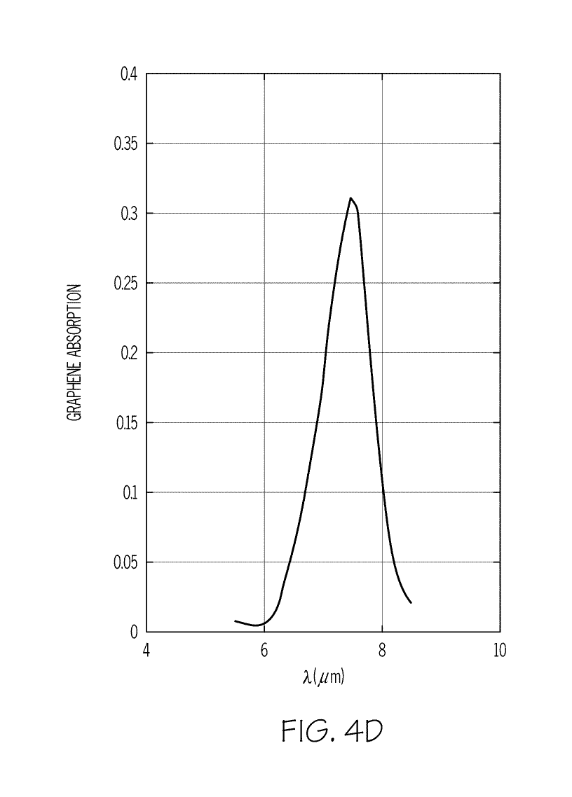

FIG. 3A depicts a broadband PFET 103 (linearly dichroic) that only responds to x-polarization in accordance with an embodiment of the present invention. FIG. 3B depicts a chiral PFET 103 that distinguishes left-handed and right-handed circularly polarized light (and different ellipticities) in accordance with an embodiment of the present invention. FIG. 3C depicts a narrowband PFET 103 (Fano-resonant) that provides a narrow-width resonance for x-polarization only in accordance with an embodiment of the present invention. Furthermore, the narrowband PFET 103 provides high quality resonance with large field enhancement. FIG. 3D depicts metasurface 102 using the PFET of FIG. 3A in accordance with an embodiment of the present invention. For y-polarization, metasurface 102 reflects all the light. Therefore, only x-polarized light is transmitted. In one embodiment, metasurface 102 can be used as a broadband photodetector that can measure the amplitude of light as well as the polarization state for linearly polarized light. There is no photocurrent generated for the y-polarization. FIG. 3E depicts metasurface 102 using the PFET of FIG. 3B in accordance with an embodiment of the present invention. In one embodiment, metasurface 102 can measure the ellipticity of the light. Furthermore, in one embodiment, metasurface 102 can be used as a photodetector that produces 5-10 times more photocurrent for the left-handed circular polarization than right-handed circular polarization (as shown in FIGS. 4A-4D). Furthermore, it can distinguish the ellipticity of light accurately which can be useful in increasing the bandwidth of telecommunication by polarization-division multiplexing. FIG. 3F depicts metasurface 102 using the PFET of FIG. 3C in accordance with an embodiment of the present invention. In one embodiment, metasurface 102 provides a narrow-band Fano resonance with large field-enhancements in gap 203 (FIG. 2) for the light polarized along wire 204, 205. The response is shown in FIGS. 4A-4D.

FIG. 4A illustrates the absorption spectrum for the chiral metasurface in accordance with an embodiment of the present invention. The graphene absorption (for the embodiment where graphene is used to fabricate plasmonic metasurface 102 of FIG. 2) in gap 203 (FIG. 2) is shown for left-handed (line 401) and right-handed (line 402) circular polarization at the mid-infrared range of frequency. FIG. 4B illustrates the AC current profile at the resonance for the left-handed circular polarization in accordance with an embodiment of the present invention. FIG. 4C illustrates the z-component of the electric field corresponding to the electric charge profile at the resonance in accordance with an embodiment of the present invention. The large charge accumulation at the end of the monopoles results in a very large field enhancement in gap 203 for the left-handed circular polarization. FIG. 4D illustrates the graphene absorption (for the embodiment where graphene is used as a photoconductive material 102 of FIG. 2) in gap 203 for the narrowband Fano-resonance PFET shown in FIG. 3F in accordance with an embodiment of the present invention. The graphene absorption is only for light polarized along wire 204, 205 (FIG. 2).

As discussed above, device 100 includes drain and source antennas 201, 202. In one embodiment, these antennas are sized in the nanometers and serve several functionalities, including gating. Therefore, no additional gate contact is required in fabricating device 100 thereby enabling standard lithography processes to fabricate an active device 100.

Furthermore, the bolometric effect and depletion-type tuning discussed above can be performed at any frequency. By scaling the size of nanosensor 103, the resonance wavelength can cover frequencies in the visible to far-infrared range. In the embodiment where metasurface 102 is photochromic, an array of metasurfaces 102 can be integrated to one substrate 101 and cover a large spectral range of interest for detection and sensing purposes.

Additionally, the unit cell design 103 as shown in FIG. 2 may be adjusted for different applications. The design may be adjusted to enhance the electromagnetic fields with linear polarization or elliptical polarization and support high quality Fano resonances.

As a result of the design of device 100 of the present invention, electro-optical device 100 adds optical enhancement to field-effect transistors (FETs). The design of device 100 of the present invention facilitates integration of several sensors (modulators) in very small spaces. Furthermore, the flexibility of the design of device 100 allows different optical functionality (e.g., narrowband resonance, wide-band resonances, linear polarization detection and dichroic polarization detection). Additionally, device 100 may be similarly used as low-power modulators of intensity/phase and polarization.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. An electro-optical device, comprising:
an electro-optical substrate; and
one or more arrays of plasmonic unit cells forming a plasmonic metasurface fabricated on said electro-optical substrate, wherein each of said plasmonic unit cells mimics a field-effect transistor.

2. The electro-optical device as recited in claim 1, wherein each of said plasmonic unit cells comprises:
a drain antenna; and
a source antenna separated from said drain antenna by a gap.

3. The electro-optical device as recited in claim 2, wherein each of said plasmonic unit cells further comprises:
a drain wire attached to said drain antenna; and
a source wire attached to said source antenna.

4. The electro-optical device as recited in claim 3, wherein said drain and source wires run along the y-direction.

5. The electro-optical device as recited in claim 2, wherein said drain and source antennas function as electrodes, wherein a DC or AC or pulsed voltage between said drain and source antennas control the optical properties of said electro-optical substrate in said gap.

6. The electro-optical device as recited in claim 1, wherein said electro-optical substrate comprises a doped semiconductor.

7. The electro-optical device as recited in claim 1, wherein said electro-optical substrate comprises band-gap material.

8. The electro-optical device as recited in claim 1, wherein said electro-optical substrate comprises a phase transition metal-oxide.

9. The electro-optical device as recited in claim 1, wherein said electro-optical substrate is a thermochromic substrate.

10. The electro-optical device as recited in claim 1, wherein said electro-optical device is implemented in a photodetector array.

11. The electro-optical device as recited in claim 1, wherein said electro-optical device is implemented in an optical modulator.

12. The electro-optical device as recited in claim 1, wherein said electro-optical device is implemented in a multispectral imaging device.

13. The electro-optical device as recited in claim 1, wherein said electro-optical device is implemented in a tunable filter.

14. The electro-optical device as recited in claim 2, wherein said gap functions as an active region of said electro-optical device.

15. The electro-optical device as recited in claim 2, wherein a gradient of optical fields around a tip of said drain and source antennas and above said gap traps a biomolecule.

16. The electro-optical device as recited in claim 3, wherein a voltage applied to said drain and source wires causes biomolecules to attract to said drain and source wires.

17. The electro-optical device as recited in claim 2, wherein a voltage applied to said drain and source antennas results in trapping a biomolecule in said gap.

18. A method for detecting biomolecules, the method comprising:
detecting a change in physical properties of a thermochromic substrate based on a change in temperature of said thermochromic substrate which is based on a change in an amount of optical absorption due to a presence of a biomolecule with an absorption fingerprint that matches a resonance frequency of an array of plasmonic unit cells; and
detecting a presence of a biomolecule in response to detecting said change in said physical properties of said thermochromic substrate.

19. The method as recited in claim 18, wherein said change in said amount of optical absorption occurs at a unit cell of said array of plasmonic unit cells forming a plasmonic metasurface fabricated on said thermochromic substrate.

20. The method as recited in claim 19, wherein said thermochromic substrate comprises a transition metal-oxide.

21. The method as recited in claim 18, wherein said physical properties comprise one of the following: electrical conductivity and infrared (IR) transmittance.
